(19) United States
(12) Patent Application Publication
(10) Pub. No.: US 2008/0109788 A1
(43) Pub. Date: May 8, 2008

(54) System and Method for Remotely Administering a Computer Network

(76) Inventor: Joan Pons Prieto, Rarcelona (ES)

Correspondence Address: PATENT GROUP 2N;JONES DAY, NORTH POINT, 901 LAKESIDE AVENUE, CLEVELAND, OH, 44114, US

(21) Appl. No.: 11/935,832

(22) Filed: Nov. 6, 2007

Related U.S. Application Data
(60) Provisional application No. 60/857,442, filed on Nov. 7, 2006.

(51) Int. Cl. G06F 9/44

(52) U.S. Cl. 717/115

(57) ABSTRACT

In accordance with the teachings herein, systems and methods are provided for administering a plurality of computers over a wide area network (WAN). A system for administering a plurality of computers over a WAN may include software instructions configured to allow a user to define a script, software instructions configured to allow a user to define a job, and an interface that enables the system to be accessed on a variety of computing platforms. The script so defined may comprise instructions to be executed on the plurality of computers. The job so defined may comprise the script, the identity of one or more computers on which the script is to be run, instructions regarding the timing of execution of the script on the one or more computers, and data parameters that are supplied to the script upon execution.

### CROSS-REFERENCE TO RELATED APPLICATION

This application claims priority from and is related to the following prior application: “System and Method for Administering a Computer Network,” U.S. Provisional Application No. 60/857,442, filed Nov. 7, 2006. This prior application, including the entirety of the written descriptions and drawing figures, is hereby incorporated into the present application by reference.

### FIELD

The technology described in this patent document relates generally to computer network administration, and particularly to the remote administration of a network of computers.

### BACKGROUND

Organizations with networks of computers often need to administer those computers from a central location. This is especially true as the number of computers in the organization's network grows. In addition, an organization's network is not constrained to a particular geographic area, a fact that makes it imperative that the organization be able to administer the computers in its network remotely. Remote administration obviates the need for an organization to have administrative systems and staff located at every geographic location that contains computers that are part of the organization's network.

### SUMMARY

In accordance with the teachings herein, systems and methods are provided for remote administration of a network of computers. A system for administering a plurality of computers over a network may include software instructions configured to allow a user to define a script, software instructions configured to allow a user to define a job, and an interface that enables the system to be accessed on a variety of computing platforms. The script so defined may comprise instructions to be executed on the plurality of computers. The job so defined may comprise the script, the identity of one or more computers on which the script is to be run, instructions regarding the timing of execution of the script on the one or more computers, and data parameters that are supplied to the script upon execution.

### BRIEF DESCRIPTION OF THE DRAWINGS

FIG. 1 is a block diagram illustrating an example system and method for remote administration of a computer network.

FIG. 2 is a block diagram depicting another example of a system and method for remote administration of a computer network.

FIG. 3 is a block diagram depicting the function of an example system for remote administration of a computer network.

FIG. 4 is a flow diagram depicting the operation of an example system for remote administration of a network.

FIGS. 5A-5C are flow diagrams depicting various operations of a module that is part of an example remote administration system.

FIGS. 6A-6B are flow diagrams depicting various operations of a module that is part of an example remote administration system.

FIG. 7 is a flow diagram depicting a further operation of an example system for remote administration of a computer network.

FIGS. 8-21 illustrate examples of graphical user interfaces for a system used to remotely administer a computer network.

### DETAILED DESCRIPTION

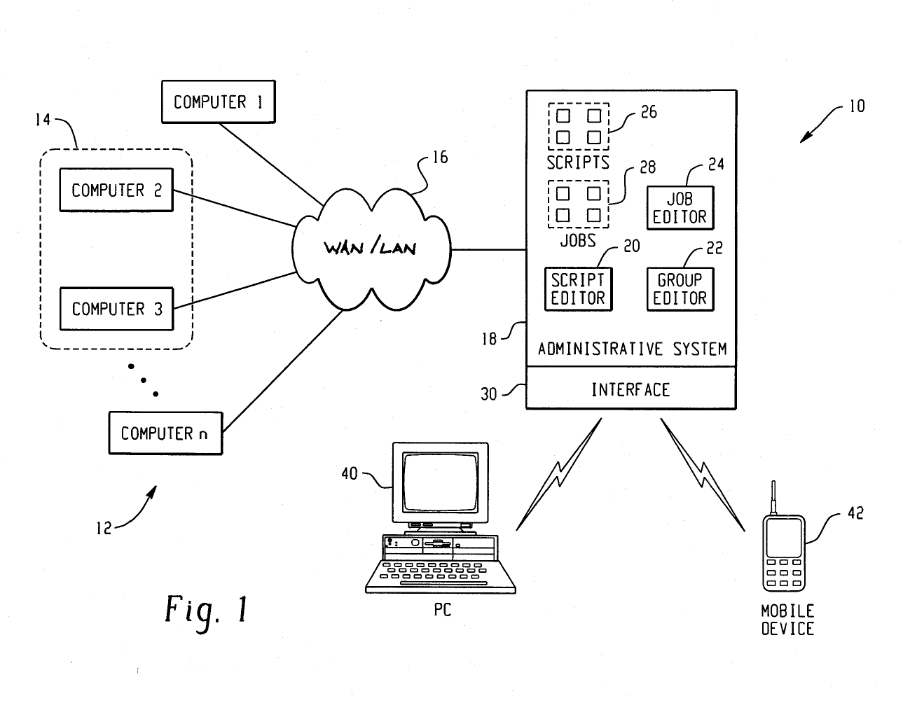

FIG. 1 is a block diagram depicting at 10 an environment in which a network of computer devices are administered remotely. The computers 12 are interconnected through a wide-area network (WAN) or local area network (LAN) 16. One or more of the computers 12 may be arranged into a group 14. The connection of the computers 12 to WAN/LAN 16 also permits the computers 12 to communicate via the WAN/LAN 16 with an administrative system 18 that is responsible for the administration of one or more of the computers 12 or groups of computers 14.

The administrative system 18 may include a number of modules that can be used during the process of administering a computer or group of computers. The script editor 20 permits a user of the administrative system 18 to create and edit scripts 26 that may, for example, contain instructions related to the administration of a particular computer or group of computers. Scripts 26 contain instructions that are intended to run automatically on remote computers that are administered by the administrative system 18. Sets of instructions such as scripts 26 may be referred to by other names, one of which is bots.

The set of instructions in a script or bot is executed on one or more computers. The group editor 22 allows a user of the administrative system 18 to perform tasks such as defining a group of computers, adding a computer to a group of computers, or removing one or more computers from a group of computers. When a user of the administrative system 18 wishes to specify script instructions to be executed remotely and the identity of a computer or group of computers on which the instructions should be executed, the user creates a job. The job editor 24 allows the user to define and edit jobs 28. Jobs 28 contain the script instructions, computer identification, and other information necessary to execute scripts 26 on computers or groups of computers that are administered by the administrative system 18. Examples of the other information a job may include are information about the timing of executing the job on the computer or group of computers or settings indicating to the administrative system how to process the output of a script that is executed remotely on one of the computers the administrative system 18 is responsible for administering. Another example of the other information a job may include is a parameter that is passed to the script upon execution, for example an authentication parameter that would allow the administrative system 18 to have secured access to one or more of the computers it is responsible for administering.

A user of the administrative system 18 interacts with the system through an interface 30. The interface 30 may comprise one interface (such as a web page) that is accessible from a variety of computing devices, such as a personal computer (PC) 40 or a mobile device 42, or the interface 30 may comprise a number of adaptations of an interface to the administrative system 18, each configured to run properly on the target device, such as PC 40 or mobile device 42. An example of this latter type of interface could include, for example, an interface programmed in the Java programming language, where the computing devices a user might employ to interact with the administrative system 18 would download a common set of binary files, but each computing device would display the interface in a slightly different way, optimized for example, for a relatively small screen, such as on mobile device 42, or for a particular operating system, such as Windows or the MacOS, which may run on PC 40.

The computing devices that interact with the administrative system 18 via the interface 30 may communicate with the administrative system 18 in a number of ways. For example, mobile device 42 could be connected to a wireless data link, such as CDMA, EDGE, or Wi-Fi, which then would connect to a wide-area network to which the administrative system also is connected. Alternatively, the mobile device 42 could communicate directly with the administrative system as, for example, if the administrative system were running on a personal computer and the mobile device 42 were connected to that personal computer via a USB cable. Similarly, other computing devices a user could employ to interact with the administrative system 18 via the interface 30, such as the PC 40, may communicate with the administrative system 18 in a number of different ways.

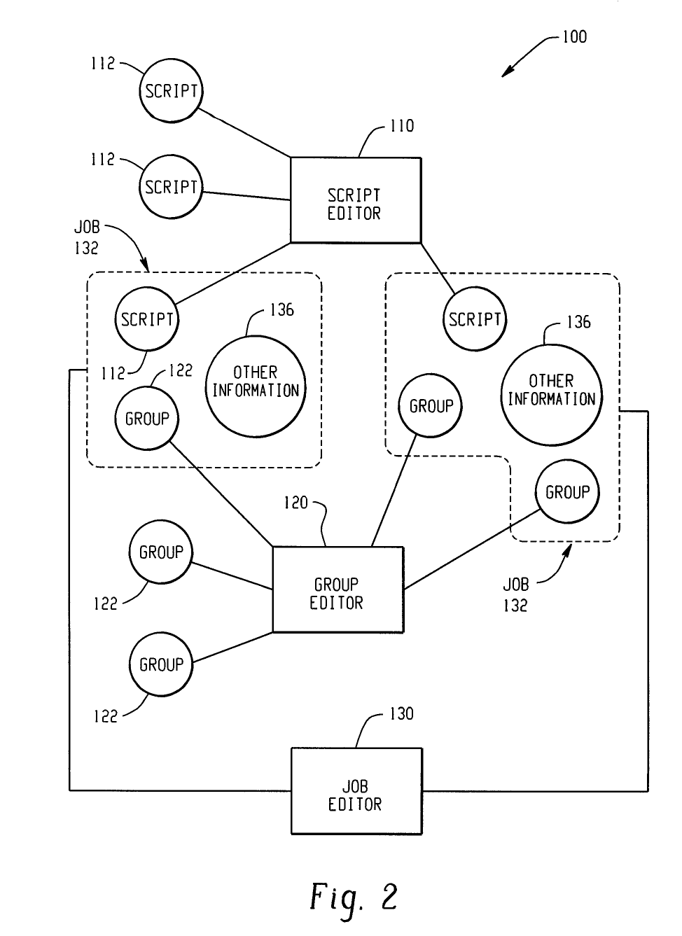

FIG. 2 is a block diagram that depicts another example of how a remote administration system 100 that administers a network of computers could function. The script editor 110 is a module that is used to generate and/or edit scripts 112. The scripts 112, which also could be referred to as bots, contain instructions that are to be executed on a computer or group of computers. Thus, at the instruction of a user of the administration system 100, the script editor would create one or more scripts 112, which the user would edit to include the required instructions. The instructions in the scripts could be entered in any language that is supported by the remote administration system 100. Examples of potential languages in which script instructions could be written include JavaScript, VBScript, and Python. As a general rule, scripting languages such as those listed can be mastered more easily than more traditional programming languages such as C++. This ease of use typically permits a broader range of users to undertake the authoring of a script than would be able to develop a program in a more traditional programming language. Thus, the remote administration system 100 is more useable by a larger set of people. Also, a user of the system may make use of a script 112 on its own, executing the script within the remote administration system 100, rather than executing it remotely in an automated fashion, as takes place in the context of a job.

Once a user of the remote administration system 100 has created and authored one or more scripts 112, the user may continue the process of setting up the remote administration of one or more computers. The next step typically would involve the user operating the group editor 120 to define one or more groups 122 of computers, each group containing at least one computer. The group editor will create, for example, a file or files to be stored on the remote administration system 100, which will contain the details about the one or more computers that will comprise the group. The group editor 120 updates the file or files as necessary when the user edits the composition of the groups 122. Given that the administration system 100 is capable of operating remotely, ideally the group editor would permit a user to define groups containing widely disparate computers, with the only requirement being that they all are in communication via the WAN with the administration system 100. The administration system 100, though, also may be configured in a variety of ways, some of which could limit the groups, for example, to only computers within an organization or to only computers that are located in a particular geographic area. Regardless whether the administration system or the networks to which the computers are connected impose any such constraints on the operation of the administration system 100, the modules, including the group editor 120 and the script editor 110, should operate in a consistent manner when used by the user of the administration system 100.

The final module in this example of implementing the remote administration system 100 is the job editor 130. The job editor 130 allows a user of the administration system 100 to create and edit the settings for jobs 132 that will ultimately be run by the administration system 100 on one or more of the computers the system is responsible for administering. A job 132 includes the script 112 that contains the instructions to be executed on one or more groups of computers 122. The identity of the one or more groups of computers 122 also is part of the job 132. The job editor 130 allows a user to create and edit within the job these associations with a script 112 and a group of computers 122. One benefit of the job editor 130 is the ease with which a user can change the script 112 that the user wishes to run on a group of computers 122. The job 132 also contains other information 136, which may include one or more parameters that are to be passed to the script upon execution or information about the timing of execution of the script. The script editor 130 allows a user to define this additional information that the administration system 100 will use when executing the job 132 on the group of computers 122 that is part of the job. The example system described herein is very flexible, permitting a user to define numerous jobs 132, each potentially executing different scripts on different groups of computers. Thus, the example system allows the user to construct with minimal effort a thorough, easily-maintained system for remotely administering the computers connected to the administration system 100.

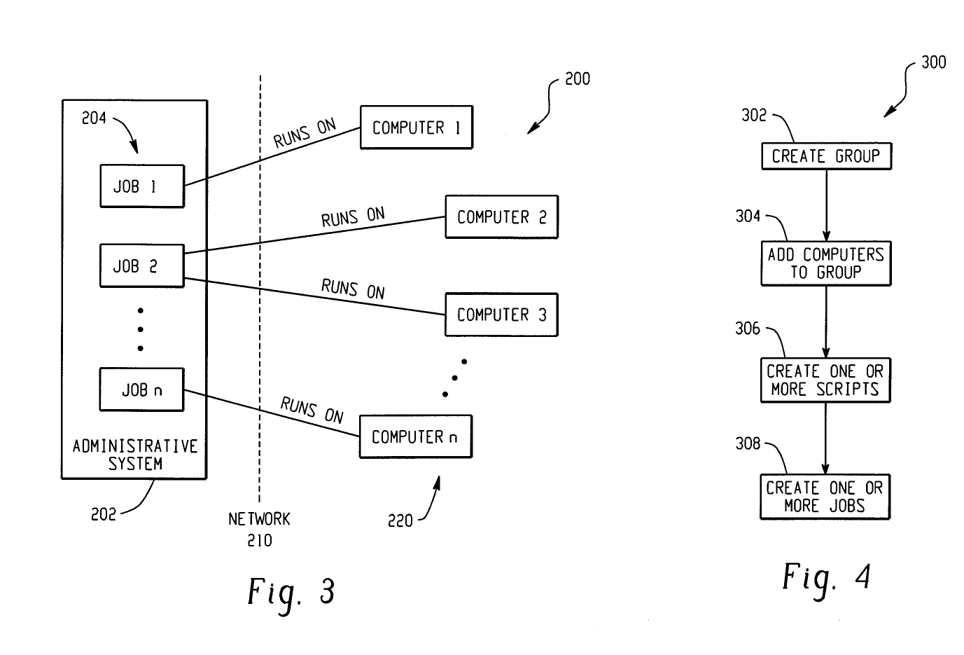

FIG. 3 depicts the function of an example system 200 for administration of a network of computers. The administrative system 202 manages user-defined jobs 204. As discussed previously, the jobs 204 contain script instructions, the identity of the computers on which the script instructions are to be executed, and other information that may be necessary in order for the administrative system 202 to properly execute the jobs 204 on one or more computers 220 that the administrative system 202 is responsible for administering. The administrative system 202 and the computers 220 that it administers communicate via a network 210. The administrative system 202 runs one or more of the jobs 204 on one or more of the computers 220. As the computers 220 are in communication with the administrative system 202 via the network 210, it is further possible for the results and/or output of the jobs 204 to be transmitted back to the administrative system 202 from the computers 220 and this information may be stored by the administrative system 202. The information resulting from the running of jobs 204 that is stored by the administrative system 202 also may be displayed on an interface of the administrative system or transmitted to a device with which a user of the administrative system 202 access the interface to the administrative system. The administrative system 202 can perform these tasks whether the computers 220 administered are off-line or on-line and without regard to whether the computers 220 are assigned public IP addresses or fixed IP addresses. In addition, the action of running jobs 204 can be massively executed to all administered computers 220 at one time, regardless whether the computers 220 are off-line or on-line or whether the computers 220 have been assigned public or fixed IP addresses. In addition, it is possible in the example system to carry out the administrative tasks described herein even if the administrative system 202 is not on the same network as the computers 220 it administers.

The administrative system 202 also may use the communication link between itself and the computers the system administers 220 over the network 210 to transmit data other than jobs to the computers 220. For example, the system allows for the deployment of software programs, which are sent from the system to the computers 220 over the network 210. Once the software programs are received by the computers 220, they may, for example, be executed on the computers 220 or stored in data stores on the computers 220 for execution at a later time.

FIG. 4 is a flow diagram depicting the operation of an example system 300 for remotely administering a network of computers. At step 302, a user of the system 300 creates a group to include one or more of the computers that are remotely administered by the example system 300. Once a group has been created, the user next adds one or more computers to the group, as shown at step 304. The group will form part of the job, and script instructions will be executed on the computers that are members of the group. At step 306, the user creates one or more scripts. The one or more scripts include the instructions that will be executed as part of a job. At step 308, the user creates one or more jobs. The jobs combine the previously-created group of computers and script. The group of computers controls which computers execute the instructions that are contained in the script. The jobs also include additional information necessary for execution of the job, such as parameters to be passed to the scripts upon execution and information about the timing of execution of the job.

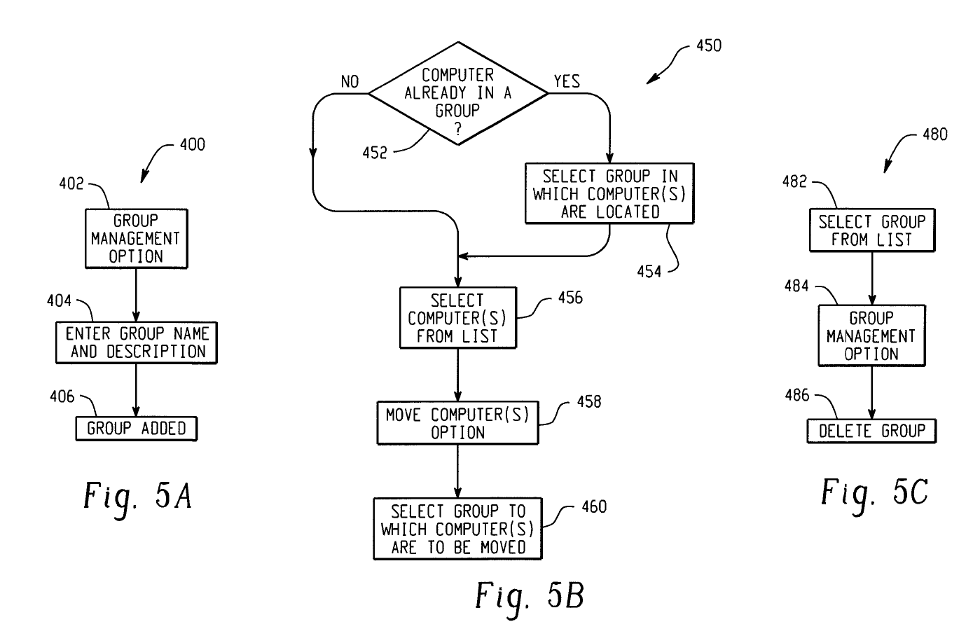

FIGS. 5A, 5B, and 5C are flow diagrams depicting various operations of a group editor module from an example remote administration system. In FIG. 5A, the diagram at 400 depicts the flow of creating a new group using the group editor. Using one of the available interfaces to the administration system, the user at 402 selects the group management option, which may be used to control the various aspects of creating, editing, and deleting groups of computers in the example administration system. The user enters a name and a description for the group that is to be created, as depicted at 404. This step also could be accomplished through the use of one of the interfaces available for the example administration system. Once the user completes these steps, the new group is created at 406, and the user may begin to use the group in other aspects of the system, such as including the newly-created group in the definition of jobs, or to transfer data to the computers that comprise the group.

FIG. 5B depicts at 450 an example of the process flow of moving one or more computers from one group to another. At 452, the user determines whether the desired one or more computers already is contained in a previously-defined group in the example remote administration system. If the one or more computers are contained in a previously-defined group, the user selects the group in which one or more of the computers is located 454. If the one or more computers are not already in a group, or the user has selected the group in which the one or more computers are located, then the list displayed by the interface through which the user interacts with the example administration system displays a list of the computers that may be selected. The user selects from the list the one or more computers that are to be moved, as shown at 456. With the one or more computers selected, the user chooses the move computer(s) option 458 in the interface. At 460, in order to perform the moving of the one or more computers, the system requests that the user select the destination group to which the one or more computers are to be moved. The group selected by the user will contain the one or more computers selected by the user to be moved.

At 480, FIG. 5C illustrates an example process flow for deleting a group defined within the example administration system. The user selects a group from the list of groups at 482. At 484, the user selects the group management option. Selecting the group management option presents the user with a variety of actions that may be taken through the example administration system. In order to delete the selected group, the user selects the delete group option, as shown at 486. The group selected by the user will be removed from the example administration system.

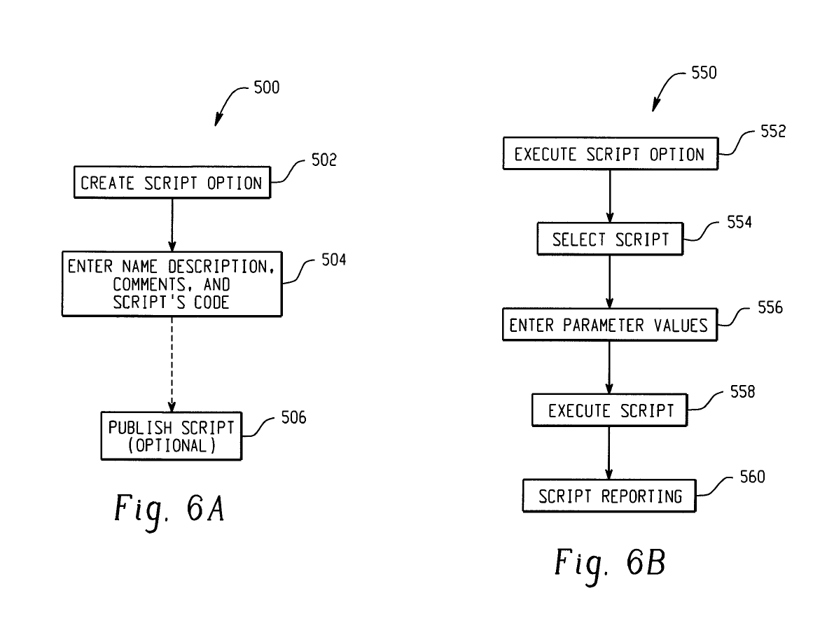

FIGS. 6A and 6B are example process flow diagrams depicting various operations the user may undertake using the script editor module of the example administration system. FIG. 6A depicts at 500 the process flow for creating a new script using the script editor module. At 502, the user selects the create script option. Selecting this option causes the example administration system to generate a new file to store the script instructions as well as data about the script, such as the name or description. The user at 504 enters the name and description information and also authors the instruction code the script will contain. Once the user has entered this information, the script is complete and is saved by the example administration system. The user may undertake the additional, but optional step, of publishing the script, as depicted at 506. By publishing the newly-created script, the user makes the script public, and the example administration system will allow other users to make use of the script in defining their own jobs.

FIG. 6B illustrates at 550 the example process flow of executing a script within the example administration system. At 552, the user selects from the example interface the execute script option. The example administration system prompts the user to select which script to executes, as depicted at 554. The user enters parameter values for the selected script 556. The selected script is executed at 558, with the parameters, if any, entered by the user at step 556 being passed to the script at the time of execution. Once execution of the script is complete, results are reported from the script, as shown at 560. These results also may be written to a log file, either a default file within the example administration system or a file chosen by the user of the example administration system.

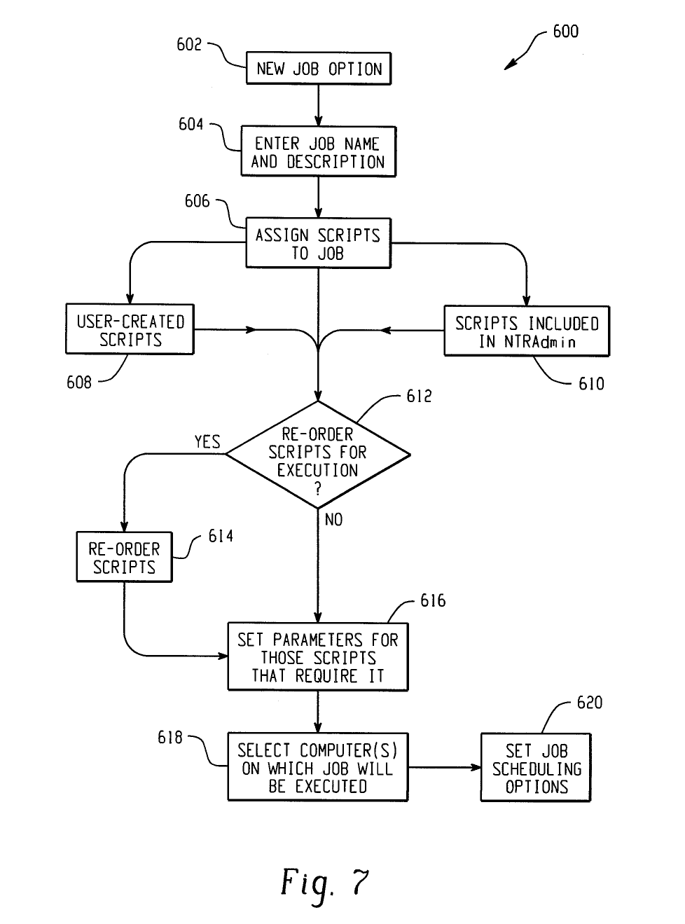

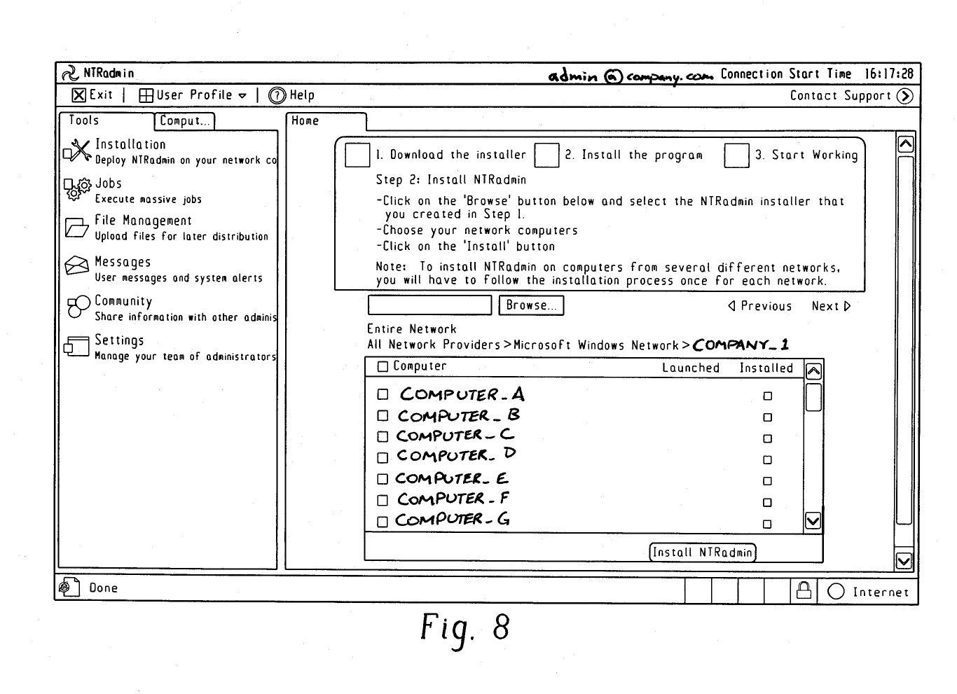

FIG. 7 is a flow diagram depicting at 600 an example process flow for operation of the job editor module of the example administration system. Using the interface through which the user is interacting with the example administration system, the user selects the new job option 602. This causes the example administration system to create a file that will be used by the system to store various information about the job. At 604, the user enters information about the job, such as a name for the job and a description of the job. This information is stored in the file created by the example administration system. The user further defines the job at 606 by assigning one or more scripts to the job. The scripts assigned to the job may include either or both of user-created scripts 608 or scripts that are included by default in the administrative system 610, an example of which is NTRadmin, available from Net Transmit & Receive of Barcelona, Spain. The user-created scripts are those scripts authored by a user and stored in the example administration system, whether they were scripts authored by the user creating the job or scripts authored by other users that were published so they would be available to other users of the example administration system.

When the user selects multiple scripts to be assigned to the job, the scripts are not necessarily added to the job in the order in which the user wishes for them to be executed. Thus, at 612, the user determines whether the scripts must be re-ordered so they will execute in the order the user desires. If re-ordering of the scripts is necessary, then the re-order step 614 is undertaken. If no re-ordering of the scripts is necessary, or if re-ordering is complete, the user sets parameters for those scripts that require parameters, as depicted at 616. The parameter information entered will be saved as part of the job within the example administration system. At 618, the user selects which computer or group of computers the job should be executed on, and this information is also saved within the example administration system as part of the job. The user sets scheduling options for the job at 620, and the scheduling options too will be saved as part of the job.

FIGS. 8-21 illustrate example user interfaces for a system for remote administration of a computer network. Each figure shows various aspects of the example interfaces that a user might encounter while using the example administration system. The user interfaces depicted in FIGS. 8-21 are most similar to those that would be encountered by a user interacting with the example administration system via a PC, but the concepts and many elements of the interfaces are common to the various interface a user might encounter depending on the type of computing device with which the user interacted with the example administration system.

FIG. 8 depicts the main interface of an example system for remote administration of a computer network, also known as the home screen. In the left pane of the home screen, the user, who also may be referred to as an administrator, is presented with a selectable list of the various components available within the system. The first of these components is the installation component, which allows the administrator to perform tasks such as downloading the installer program for the remote administration system and to remotely deploy the installer program to the computers that are administered by the example administration system. When a particular computer is chosen for deployment of the installer program, the code that is installed on the deployment computer allows the example administration system to perform operations on that computer, up to and including taking full control of the computer. This control also may be used, for example, to execute scripts, copy files to, or install additional programs on the deployment computer.

The second component represented in the left pane of the home screen is the jobs component, which permits an administrator to manage and execute the jobs that are defined within the system. For example, an administrator may choose a job and one or more of the computers that are administered by the system and then choose to execute the job. Also, the administrator may access the reports generated by previously-executed jobs and the reports generated by the scripts that comprise parts of the jobs defined within the system. This component also gives the administrator access to advanced job settings.

The third component depicted in the left pane of the home screen is the File Management component, which allows the administrator to upload files onto the example administration system that may at some later time be copied to one or more of the computers that are administered by the system.

The fourth component in the left pane of the home screen is the messages component, which gives the administrator access to user messages and system alerts that are generated by the example administration system and its users.

The fifth component in the left pane of the home screen is the community component. The community component permits the administrator to exchange information with administrators of other installations of the example administration system. The other installations of the example administration system may be within an organization, or they may even be at other organizations. The example administration system permits its administrators to share information on forums with the administrators of other administration systems and also to share the scripts that they develop and those developed by the administrators of the other administration systems. The community component is one example of the functionality that is part of the example remote administration system that may be used for communicating and interacting with other users of the example administration system or with users of other remote administration systems. Another example of this functionality is the instant chat function. The instant chat function allows users who are connected to the example administration system to share with one another text messages that will appear on the administered computers and/or within the interface of the example administration system.

The sixth and final component in the left pane of the home screen is the settings component, which the administrator uses to configure various aspects of the example administration system, including managing the public scripts and received scripts within the system, managing the accounts within the system that have been given administrator-level privileges, updating news about the administration system, and sharing computers within the example administration system.

The right pane of the home screen depicted in FIG. 8 shows further details of the installation component, including the options of downloading and installing the code necessary to give the administration system control over the computers it administers and the list of computers the administration system administers.

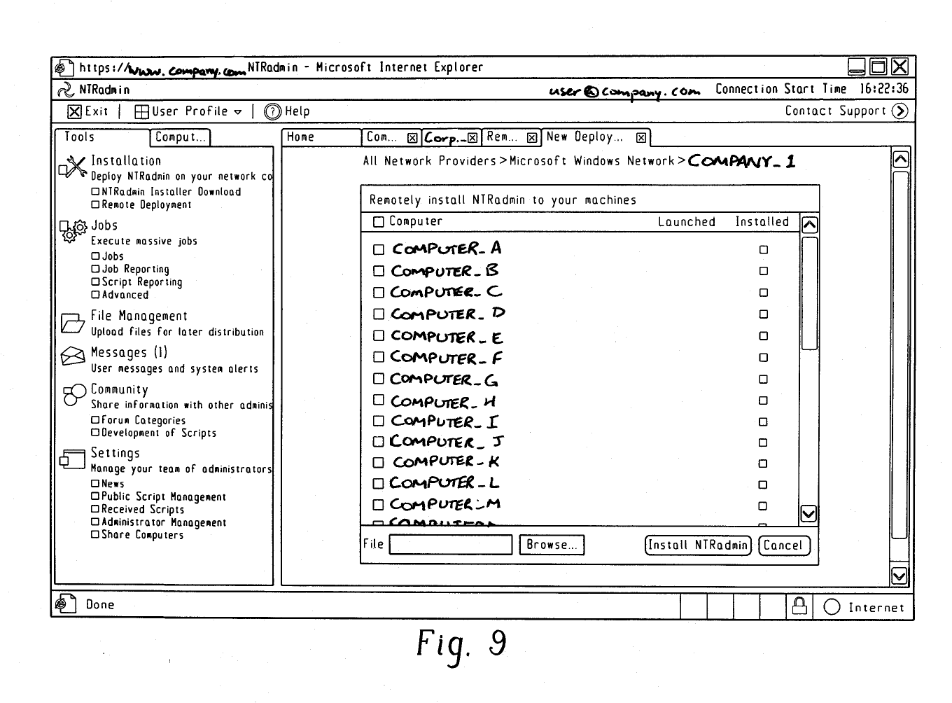

FIG. 9 illustrates in the right pane additional details of the deployment process an administrator follows in setting up a group of administered computers to function with the example remote administration system.

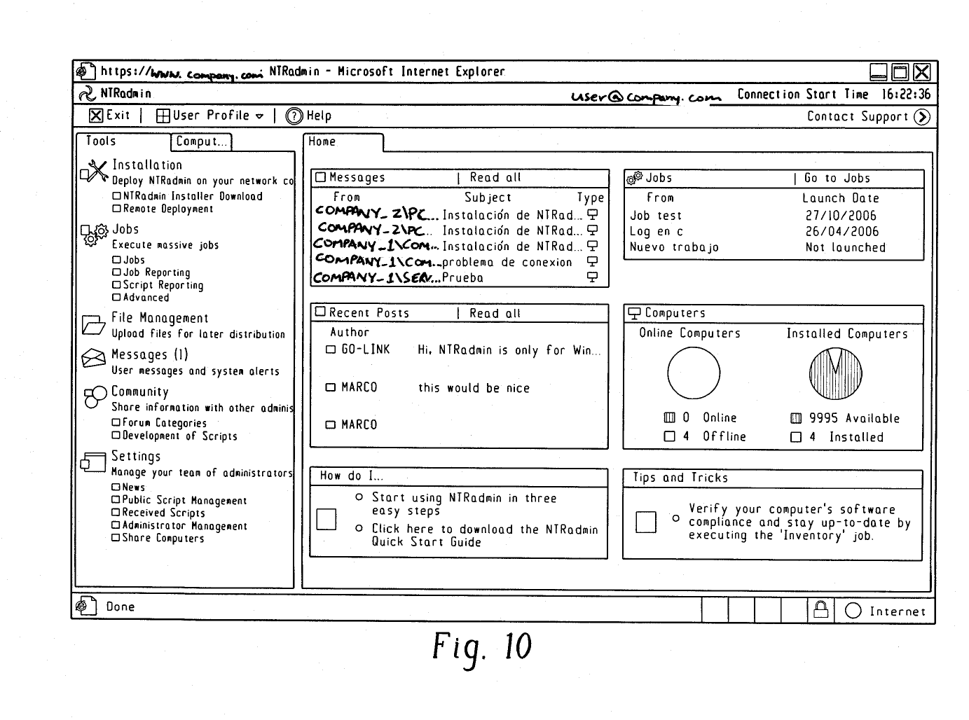

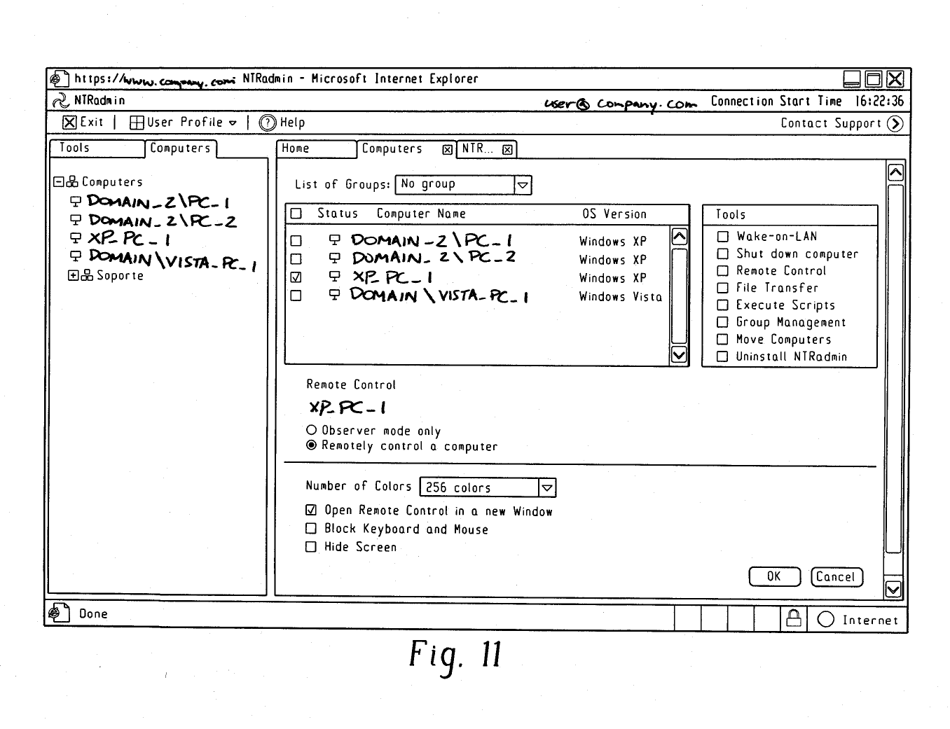

FIG. 10 shows an alternate home screen view of the example administration system. In this view, a variety of information about the example administration system is presented to the administrator. This information includes a list of pending jobs within the system, a list of messages generated within the system, posts to a forum in which this system is a participant, information about the computers administered by the example administration system, and various information designed to provide assistance to the administrator in using the example administration system.

FIG. 11 depicts another alternate interface view within the example administration system. This example provides the administrator with further tools used to administer one or more of the computers that the example administration system is responsible for. The left pane in this alternate interface displays a tree-style view of the computers that are administered by the example system. At the same time, the right pane shows additional details about the computers listed in the left pane and provides the administrator the ability to choose one or more of those computers and a tool the administrator wishes to use on the one or more computers selected.

The administrator has numerous options of tools to use, as shown in FIG. 11. Examples of the tools available are illustrated in the right pane. First, the administrator may use the Wake-on-LAN tool, which allows the example administration system to “wake up” an administered computer that is shutdown or in standby or hibernate mode by communicating certain instructions to the computer's network interface card (NIC). Another example is the shutdown tool, which permits the administrator to remotely shutdown an administered computer. A third tool is the Remote Control tool, which allows the administrator to remotely take over full control of an administered computer and use all functions of the administered computer as though the administrator were physically located at the administered computer. A fourth tool is the file transfer tool, which the administrator would use to transfer files, including new programs, to an administered computer. Fifth, the interface gives the administrator access to script execution, which permits the administrator to execute one or more scripts defined within the system. The sixth example tool is the group management tool, which gives the administrator access to the groups defined within the system, so they may be edited, and also allows the administrator to remove existing groups and/or define new groups within the system. The seventh example tool is the move computers tool, which the administrator would use to move an administered computer from one group of computers to another. The eighth and final example tool is the uninstall tool, which permits the administrator to remove from an administered computer the code that allows the example administration system to perform the various functions on the administered computer. This essentially would render the computer not administered by the example administration system, at least until such time as the control code were to be reinstalled on the computer.

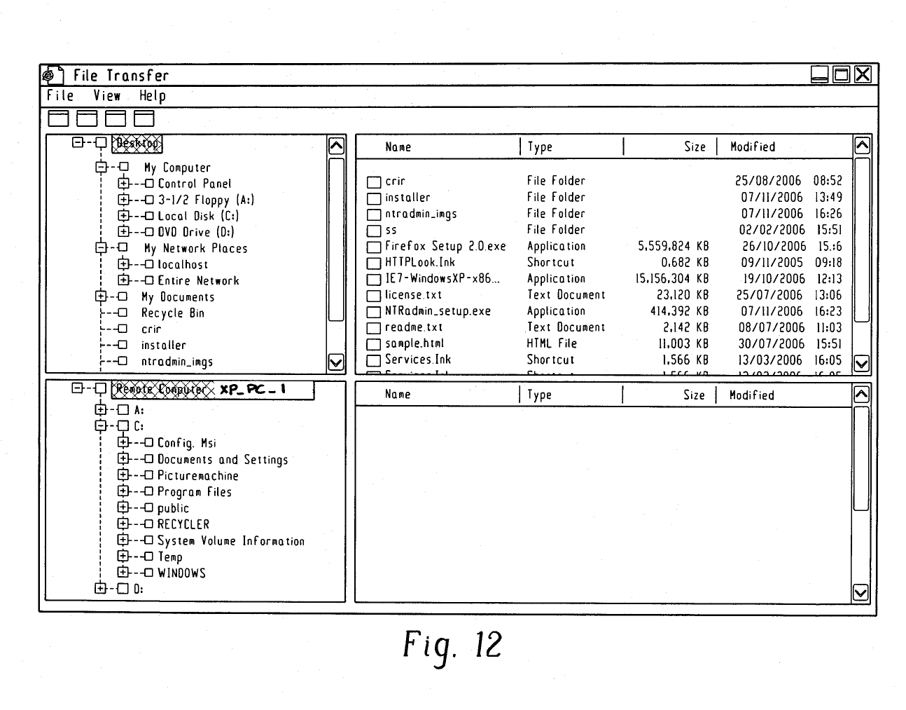

FIG. 12 is a depiction of an example interface for the file transfer tool. As shown in the interface, the administrator is presented with two views, one showing the files on the example administration system and the other showing the files on the administered computer. The administrator then would use this interface to copy files from one location to the other.

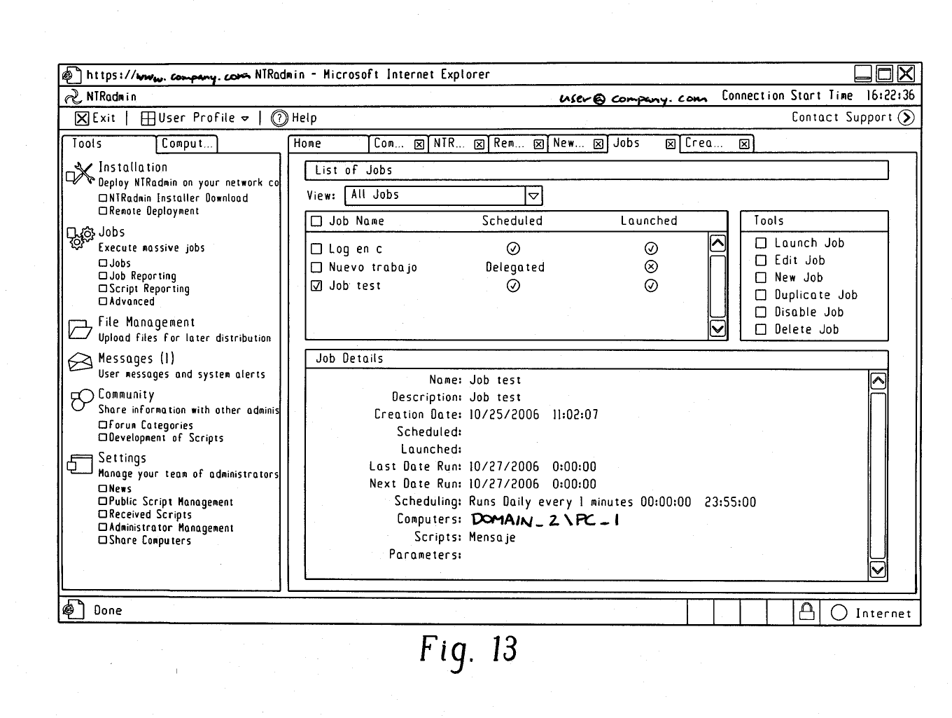

FIG. 13 illustrates an alternate home screen view of the example administration system. This view shows the information about the jobs defined in the system that is presented to the administrator and shows the tools that the administrator uses to manage those jobs.

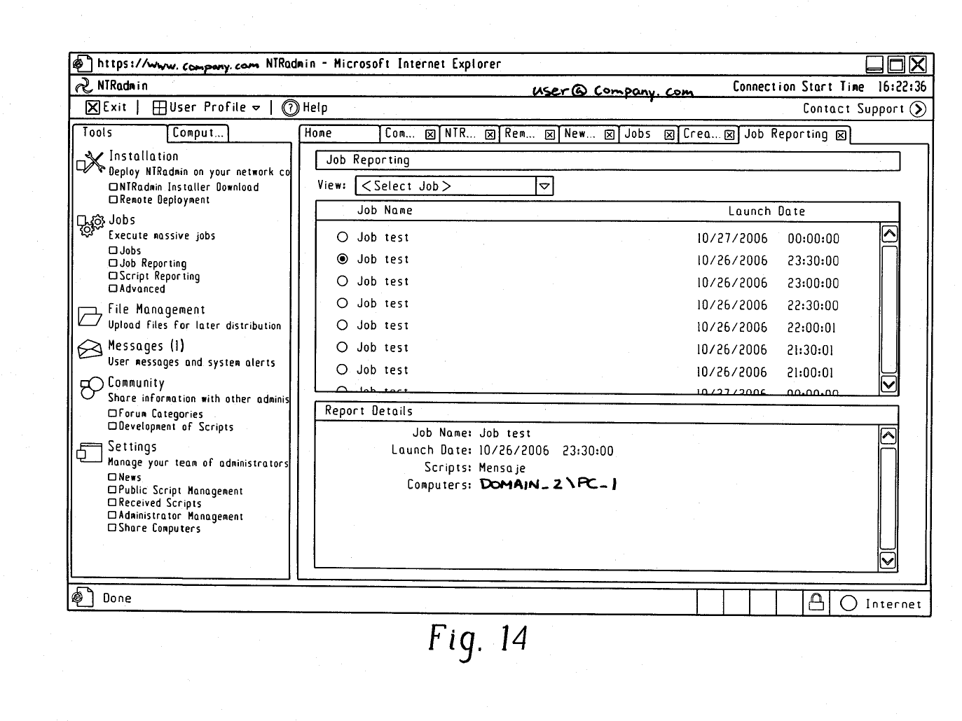

FIG. 14 depicts an alternate home screen view related to management of the jobs defined within the system. In this view, the reports generated by previously-executed jobs are made available to the administrator for review. These reports may contain information about the success or failure of a job's execution, the results of running scripts on various administered computers, the amount of time that was taken to execute a job, or other aspects of the execution of the jobs that may be important to the administrator.

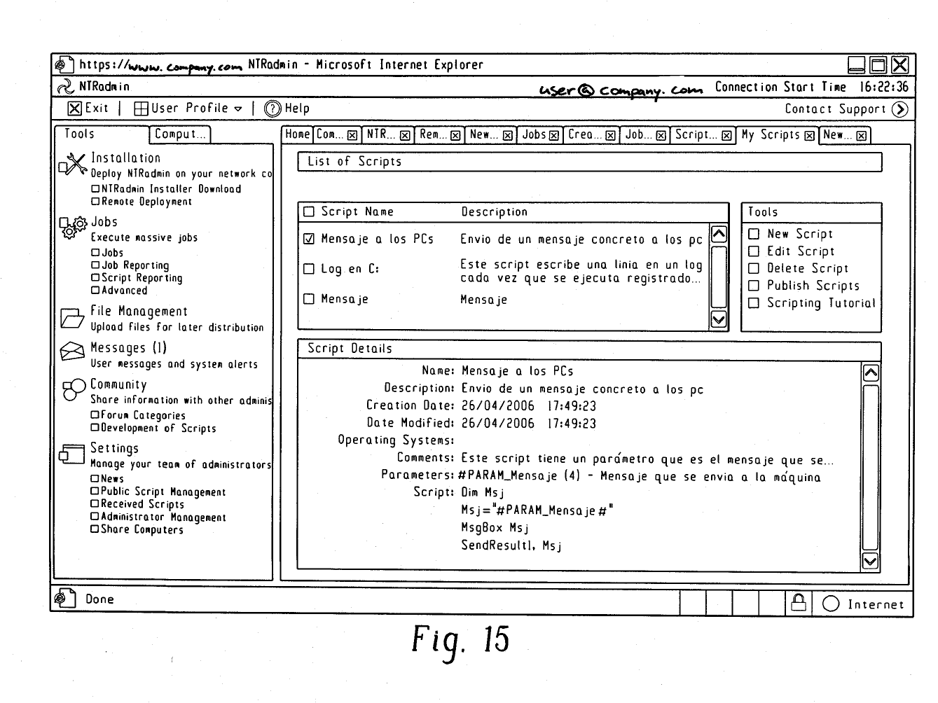

FIG. 15 shows another alternate home screen view of the example administration system. This alternate view depicts the operations related to the scripts defined within the system that are available to the administrator. The administrator may access a list of the scripts that are available within the system, details about the scripts, such as the name, description, creation and modification dates, and parameter information. The administrator also may access the various tools associated with the scripts, such as creating a new script, editing an existing script, deleting an existing script, publishing a script so that it may be accessed by other users of the example administration system (or by users of other administration systems), and a tutorial on scripting.

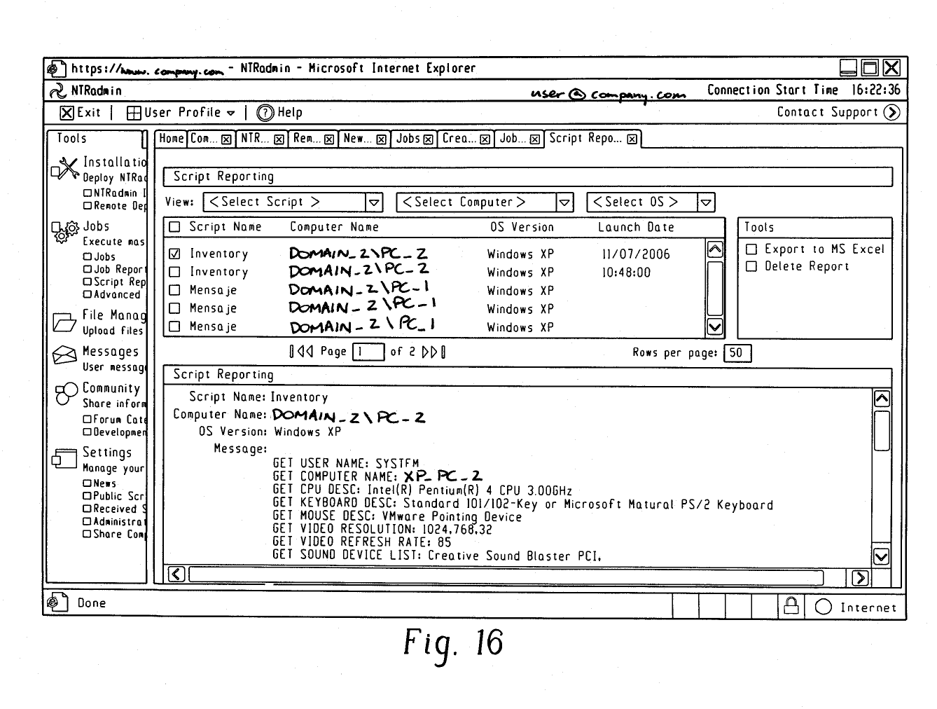

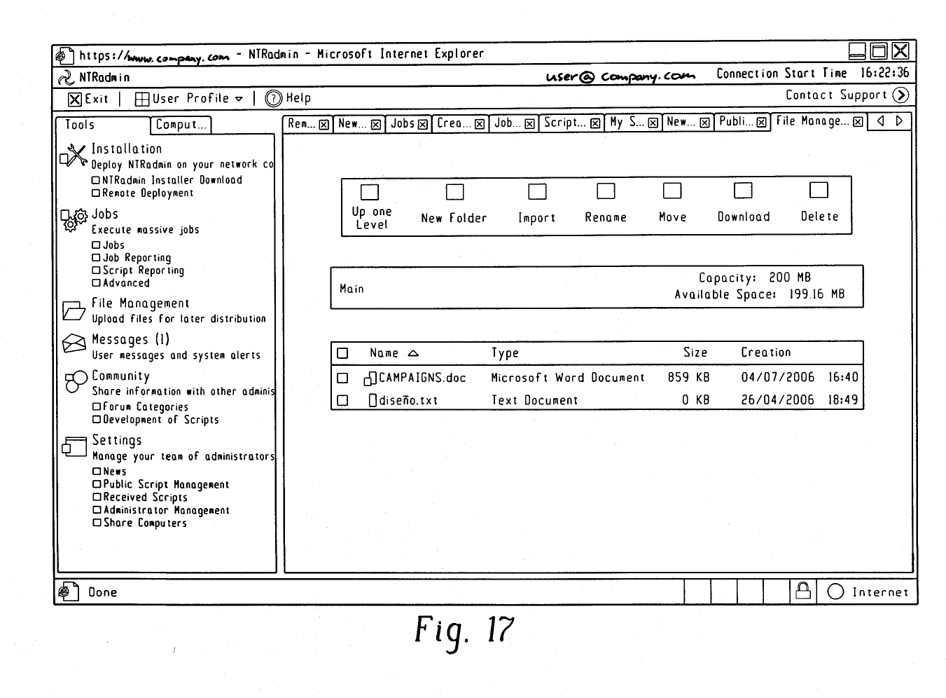

FIG. 16 depicts an alternate home screen view related to management of the scripts defined within the system. In this view, the administrator may access the reports created by the scripts. These reports may contain information about the execution of the scripts, such as output values, success or failure, or elapsed time, that may be important to the administrator of the example administration system.

FIG. 17 illustrates a home screen view related to the file management component. In this view, the administrator may upload files that can later be deployed to the administered computers by the example administration system.

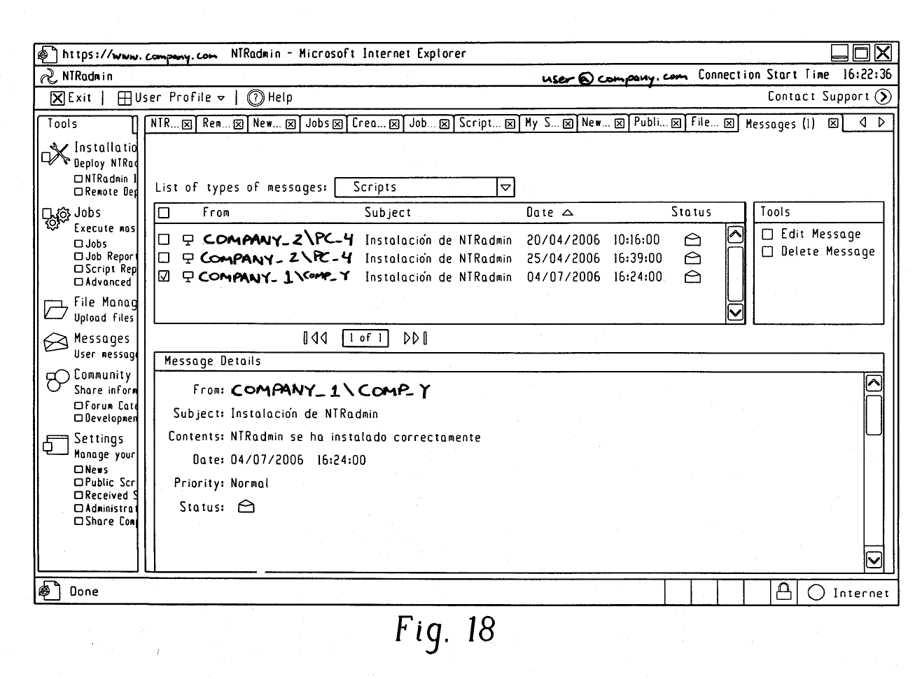

FIG. 18 shows a home screen view related to the messages component. This view gives the administrator access to the messages that have been generated from within the example administration system as well as any messages that have been sent by users of other administration system. The administrator may read messages, edit messages, and/or delete messages using this interface.

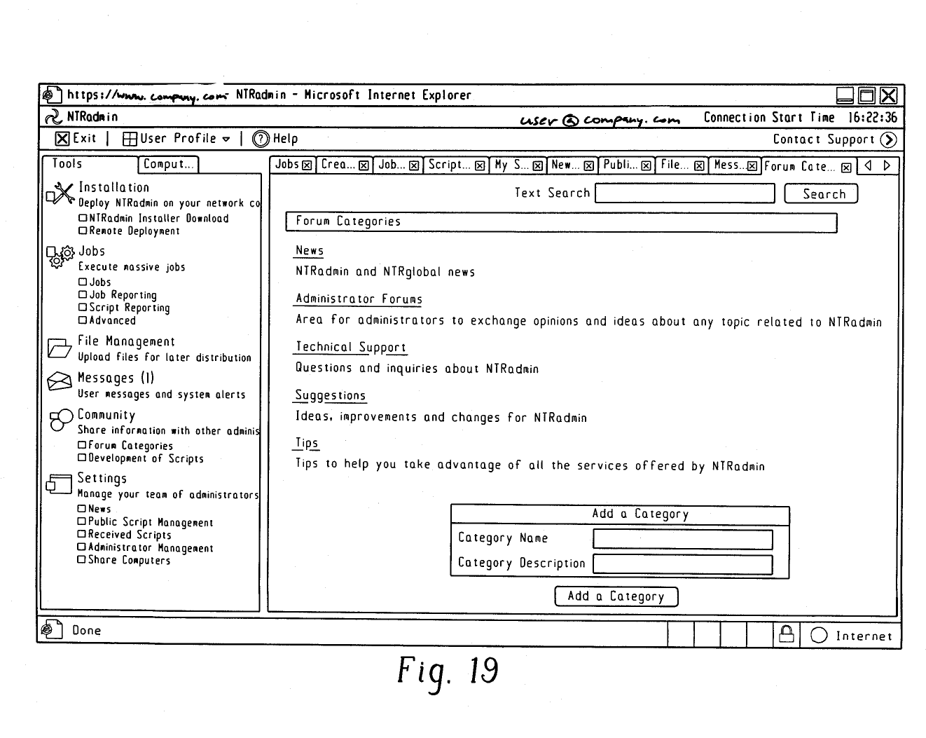

FIG. 19 depicts a home screen view for the forum component. This view shows the different categories available for communications with other users of the example administration system or users of other administration systems, if the example administration system is configured to allow such communication with outside administration systems. Communications made using the forum component, especially if made to users of other administration systems, are more public than communications through, for example, the messages component or the instant chat functionality.

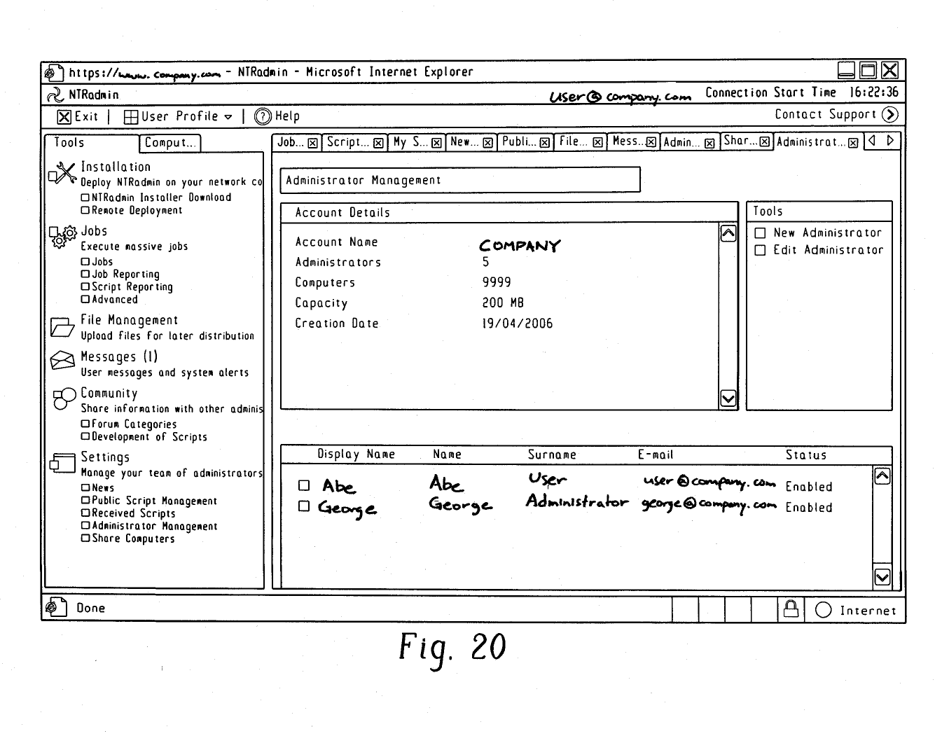

FIG. 20 illustrates a home screen view for the settings component. This view permits the administrator to manage those accounts within the system that have been granted administrator-level privileges. Information about the administrator-level accounts is displayed within the view, and the administrator has the options to, for example, create new administrator-level account or edit the existing administrator-level accounts.

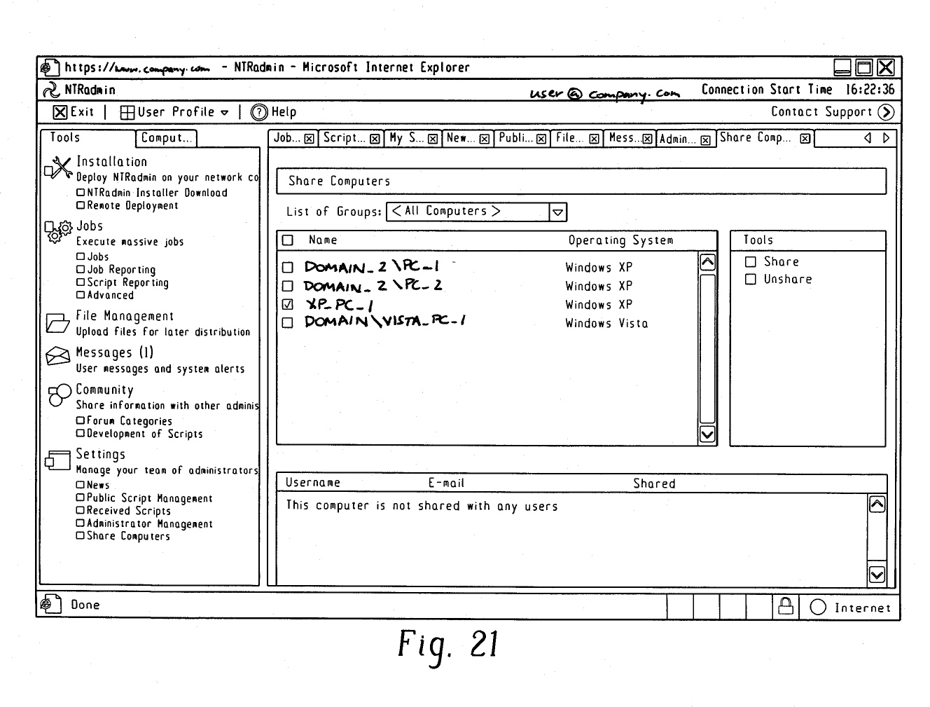

FIG. 21 shows an alternate home screen view related to the settings component. In the share computers view, the administrator is able to permit other users of the example administration system to access one or more of the administered computers. Also, the administrator is able to revoke such privileges using this view if the need should arise.

It is noted that the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

In addition, the computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A system for administering a plurality of computers over a wide area network (WAN), comprising:
software instructions configured to allow a user to define a script, wherein the script comprises instructions to be executed on the plurality of computers;
software instructions configured to allow the user to define a job, wherein the job comprises:
the script;
an identity of a group of computers selected from the plurality of computers, on which the script is to be run;
instructions regarding the timing of execution of the script on the group of computers; and
data parameters to be supplied to the script upon execution; and
an interface that enables the system to be accessed on a variety of computing platforms.

2. The system of claim 1, wherein the job is transmitted over the WAN to the group of computers.

3. The system of claim 1, wherein the job is executed on one or more of the computers in the group of computers.

4. The system of claim 3, wherein information about the status of execution of the job on the one or more computers is stored in a data store on the system.

5. The system of claim 1, wherein the computing platform used to access the interface is a wireless mobile device.

6. The system of claim 1, wherein the job is used to transmit to the group of computers a file.

7. The system of claim 6, wherein the file is a software program.

8. The system of claim 7, wherein the software program is stored in a data store at one or more of the computers in the group of computers.

9. The system of claim 1, wherein the script is written in a scripting language chosen from the group: JavaScript, VBScript, and Python.

10. The system of claim 1, wherein the system is installed at an organization, wherein users of the system may communicate with users of similar systems outside the organization.

11. The system of claim 10, wherein scripts may be shared between users of the system and users of the similar systems outside the organization.

12. The system of claim 1, wherein the user may exercise full control over one or more of the plurality of computers.

13. The system of claim 12, wherein the user may permit other users of the system to exercise full control over one or more of the plurality of computers.

14. A method for executing a task on a computer remotely over a wide area network (WAN), comprising:
providing an interface to an administrative system accessible using a wireless mobile device;
writing to a first memory store a definition of a computer group, created using the wireless mobile device, containing at least the computer on which the task is to be executed;
writing to a second memory store a script, created using the wireless mobile device, that is to be executed on the computer or computers in the computer group as part of the execution of the task;
writing to a third memory store instructions regarding the execution of the task, including the time at which the script is to be executed and the parameters to be supplied to the script upon execution; and
executing the script according to the stored instructions.

15. A method for administering a plurality of computers over a wide area network (WAN), comprising:
configuring a user-defined script, wherein the script comprises instructions to be executed on a plurality of computers;
configuring a user-defined job, wherein the job comprises:
the script;
an identity of a group of computers from the plurality of computers, on which the script is to be run;
instructions regarding the timing of execution of the script on the group of computers; and
data parameters to be supplied to the script upon execution; and
accessing a configuration interface for defining scripts and jobs using a variety of computing platforms.

16. A system for a user to administer a plurality of computers over a wide area network (WAN), comprising:
a script editor, with which the user generates a script by inputting instructions that are to be executed on a plurality of computers;
a group editor, with which the user selects one or more computers to comprise a group of computers, wherein the user assigns an identity to the group of computers;
a job editor, with which the user defines a job by selecting one or more scripts and the identity of a group of computers on which the one or more scripts are to be executed;
wherein the script editor, group editor, and job editor are executed on a computer system, which the user may access through an interface from a variety of computing platforms.

17. The system of claim 16, wherein the group of computers defined by the user is published so that other users of the system may administer computers in the group of computers.

18. The system of claim 16, wherein the script generated by the user using the script editor is published so that other users of the system may include the script in jobs defined by those other users.
